(19) United States
(12) Patent Application Publication
(10) Pub. No.: US 2008/0226814 A1
(43) Pub. Date: Sep. 18, 2008

(54) METHOD FOR MANUFACTURING PATTERNED VAPOR-DEPOSITED FILM

(75) Inventors: Yukinori Kawamura, Matsumoto City (JP); Ryohei Makino, Matsumoto City (JP); Koji Kawaguchi, Matsumoto City (JP)

Correspondence Address: ROSSI, KIMMS & McDOWELL LLP., P.O. BOX 826, ASHBURN, VA, 20146-0826, US

(73) Assignee: FUJI ELECTRIC HOLDINGS CO., LTD., Kawasaki-ku (JP)

(21) Appl. No.: 12/015,705

(22) Filed: Jan. 17, 2008

(30) Foreign Application Priority Data
Jan. 17, 2007 (JP) 2007-008423

(51) Int. Cl. B05D 5/12

(52) U.S. Cl. 427/66; 427/248.1

(57) ABSTRACT

A method for manufacturing a vapor-deposited film having a high-resolution pattern, without using a metal mask that makes it difficult to realize high resolution or an expensive laser scanning device. A patterned vapor-deposited film is manufactured by a method including: preparing a deposition panel containing a substrate, a plurality of heating elements, and a deposition material layer formed on the plurality of heating elements, the deposition material layer forming the outermost surface; disposing the deposition panel and a device substrate so that the deposition material layer faces the device substrate; and causing at least some of the plurality of heating elements to generate heat, selectively evaporating the deposition material layer that is positioned on the heating elements that have generated heat, and vapor depositing on a surface of the device substrate to form a vapor-deposited film.

### BACKGROUND

The present invention relates to a method for forming a patterned vapor-deposited film. More specifically, the present invention relates to a method for manufacturing an organic EL display panel in which at least one color from among three primary colors is emitted by a color conversion layer formed according to the shape of pixels by using the method for forming a patterned vapor-deposited film.

Research on practical applications of organic EL elements have been actively conducted in recent years. Organic EL elements are expected to realize a high emission brightness and emission efficiency because they can realize a high current density under a low voltage. In particular, practical applications of organic multicolor EL display panels that enable high-resolution multicolor or full-color display are expected. One of the methods for realizing multicolor or full-color organic EL display panels uses a plurality of color filters that transmit light within a specific wavelength region (color filter method). Organic EL elements that the color filter method is applied are required to emit the so-called “white light” in which three primary colors (red (R), green (G), and blue (B)) of light are contained with good balance.

The following methods have been studied as methods for obtaining multicolor light-emitting organic EL elements:

(1) a method in which a light-emitting layer containing a plurality of light-emitting colorants is used and the plurality of light-emitting colorants are excited simultaneously (see, for example, Japanese Patent Application Laid-open No. 3-230584 or U.S. Pat. No. 5,294,810);

(2) a method in which a light-emitting layer comprising a host light-emitting material and a guest light-emitting material is used, the host light-emitting material is excited and caused to emit light, and at the same time, energy transfer from the host light-emitting material to the guest material is induced, and the guest material is caused to emit light (see, for example, U.S. Pat. No. 5,683,823);

(3) a method in which a plurality of light-emitting layers comprising different light-emitting colorants is used, and light-emitting colorants in each layer are excited; and

(4) a method by which a light-emitting layer comprising light-emitting colorants and a carrier transport layer comprising a light-emitting dopant and disposed adjacently to the light-emitting layer are used, and part of excitation energy is transferred to the light-emitting dopant from excitons generated by carrier recombination in the light-emitting layer (see, for example, Japanese Patent Application Laid-open No. 2002-93583 or U.S. Pat. No. 6,696,177).

The above-described multicolor light-emitting organic EL elements, however, are based on simultaneous excitation of a plurality of light-emitting materials or energy transfer between a plurality of light-emitting materials. It has been reported that in such elements, the emission intensity balance between the light-emitting materials can change as the drive time elapses or following changes in the electric current that passes through the elements, the hue obtained can also change.

A color conversion method using a monochromatic light-emitting organic EL element and a color conversion layer has been suggested as another method for obtaining a multicolor light-emitting organic EL element. The color conversion layer used in this method comprises one or a plurality of color conversion materials that absorb short-wavelength light emitted by the organic EL element and convert this light into long-wavelength light. A method of coating a coating liquid in which a color conversion material is dispersed in a resin and a method of depositing a color conversion material by a dry process such as vapor deposition process have been studied as methods for forming the color conversion layer.

When the color conversion layer is formed by a dry process such as vapor deposition, the color conversion layer is usually formed on the entire display surface. However, because patterning of the obtained color conversion layer after it has been formed is difficult, separate light emission of three primary colors is impossible. Therefore, it is necessary to form a patterned film by a dry process in order to form a color conversion layer only in the positions corresponding to specific pixels. In addition, a method is needed that enables the formation of a film having a fine pattern shape that can be adapted to increased resolution of organic EL displays.

The following methods for patterning thin films of deposition materials are presently known:

(1) vapor deposition using a metal mask having openings of desired shape;

(2) a LITI (Laser-Induced Thermal Imaging) method in which a transfer member is used that is obtained by laminating a deposition material on a base substrate in advance and the deposition material only in a specific zone of the transfer member is evaporated and transferred by irradiating with a laser (see, for example, Japanese patent Application Laid-open No. 2005-5192 or US Patent Application Laid-open No. 2005/0016463); and

(3) a method in which a transfer member is used that is obtained by laminating a deposition material (organic EL layer material) on a base substrate in advance and the deposition material is transferred onto a desired substrate from only a specific zone of the transfer member by locally heating using a heat bar arranged on the rear surface side of the base substrate (see, for example, Japanese Patent Application Laid-open No. 2000-77182).

The following problems are associated with the above-described conventional methods for forming fine patterns of thin films of deposition materials.

First, material and thickness of a metal mask causes limitation on size reduction of a mask pattern. The limit on size reduction of mask pattern is presently at a resolution level of 150 ppi. The problem is that the manufacturing process becomes more difficult and yield drops in the manufacture of patterns with higher resolution. Further, a high-resolution pattern is also difficult to form on a substrate of a large surface area.

Second, because a laser and an optical system are used, the equipment employed is expensive. Further, because the laser beam has to be scanned along the pattern, the formation process takes time, the cost is high, and productivity is low.

Third, the response time (time from start to end of heating) of heating with the heat bar is long. This is because time is required to transfer heat from the heat bar that is in contact with the rear surface of the transfer member to the deposition material via the base substrate, and the base substrate having a large thermal capacity is heated and cooled slowly. There is a risk of such long response time creating problems associated with controllability of the deposited film.

In view of the above, it would be preferable to provide a method that enables the formation of a vapor-deposited film having a high-resolution pattern shape, without using an expensive laser scanning device or a metal mask that makes it difficult to realize high resolution. More specifically, it would be preferable to provide a multicolor light-emitting display panel of a color conversion system by selectively vapor depositing a color conversion material and forming a color conversion layer with a fine pattern.

### SUMMARY OF THE INVENTION

In accordance with the present invention, a deposition material layer is formed on the outermost surface of a deposition panel having formed thereon a pattern of a plurality of heating elements that generate heat when an electric current flows therein. A device substrate is disposed opposite the deposition panel inside a vacuum chamber. The selected heating elements are heated by passing an electric current therethrough, and the deposition material positioned above the heated heating elements is selectively evaporated and vapor deposited on the device substrate. Here, the plurality of heating elements may be arranged in an island-like or linear fashion. Further, the deposition panel preferably has a structure enabling the independent supply of electric current to a plurality of heating elements.

More specifically, a multicolor light-emitting display panel of a color conversion system can be provided by using a material having a color conversion function as the deposition material, using an organic EL display substrate having arranged therein a plurality of organic EL elements of a top emission type as the device substrate, and selectively forming a color conversion layer in positions corresponding to some of a plurality of organic EL elements.

With the configuration in accordance with the present invention, a patterned vapor-deposited film can be formed by heating only the selected heating elements of the deposition panel in a state in which they face the device panel and selectively evaporating the deposition material located on the selected heating elements. With the method in accordance with the present invention, a pattern of desired high resolution can be easily formed because no metal mask is used. Further, because no laser scanning device is used, a patterned vapor-deposited film can be formed inexpensively and within a short time.

In addition, because only the deposition material in a necessary zone is heated directly and selectively by using thin-film heating elements with a small heat capacity, the time from start to end of the heating process can be shortened. As a result, operability of film deposition can be improved, cycle time during mass production can be shortened, and production efficiency can be increased.

Moreover, by providing a plurality of heating elements formed in an island-like fashion and forming the wirings connected to these heating elements in a matrix-like fashion, it is possible to control each of a plurality of heating elements independently. Therefore, a vapor-deposited film of any complex pattern shape can be formed.

Further, an organic EL light-emitting display panel can be formed by using an organic electro luminescent display substrate of a top emission type in which a reflecting electrode, an organic EL layer, and a transparent electrode are laminated in the order of description on a support base and by forming a color conversion layer having a pattern shape on the upper surface of the transparent electrodes. The organic EL display panel thus obtained is a multicolor light-emitting display panel having a high resolution in which color converted light is emitted in the positions where the color conversion layer is arranged, and in other positions the light is emitted through color filters.

### BRIEF DESCRIPTION OF THE DRAWINGS

The invention will be described with respect to certain preferred embodiments and the accompanying drawings, wherein:

FIG. 1 illustrates a method for patterning a thin film of a deposition material in accordance with the present invention;

FIGS. 2A and 2B are top surface views of a deposition panel used in the method in accordance with the present invention; FIG. 2A illustrates the case where heating elements of a linear shape are used; FIG. 2B illustrates the case where heating elements of an island shape are used;

FIGS. 3A and 3B illustrate the method for manufacturing a deposition panel having matrix wirings in accordance with the present invention; FIG. 3A is a top surface view; FIG. 3B is a cross-sectional view illustrating a cross section obtained by cutting along the cutting line 3b-3b;

FIGS. 4A and 4B illustrate the method for manufacturing a deposition panel having matrix wirings in accordance with the present invention; FIG. 4A is a top surface view; FIG. 4B is a cross-sectional view illustrating a cross section obtained by cutting along the cutting line 4b-4b;

FIGS. 5A and 5B illustrate the method for manufacturing a deposition panel having matrix wirings in accordance with the present invention; FIG. 5A is a top surface view; FIG. 5B is a cross-sectional view illustrating a cross section obtained by cutting along the cutting line 5b-5b; and

FIGS. 6A and 6B illustrate the method for manufacturing a deposition panel having matrix wirings in accordance with the present invention; FIG. 6A is a top surface view; FIG. 6B is a cross-sectional view illustrating a cross section obtained by cutting along the cutting line 6b-6b.

### DESCRIPTION OF THE PREFERRED EMBODIMENTS

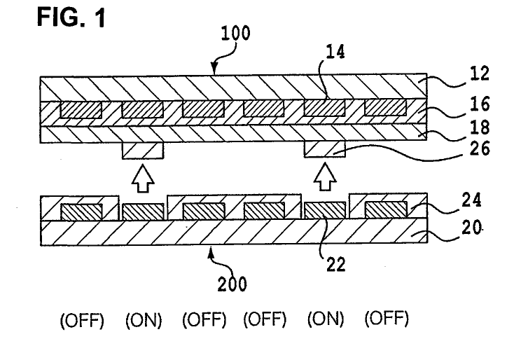

Embodiments of the present invention will be described below with reference to FIG. 1. FIG. 1 shows a configuration using an organic EL display substrate of a top emission type as a device substrate 100 in which a reflecting electrode 14, an organic EL layer 16, and a transparent electrode 18 are arranged on a TFT substrate 12.

In addition to the organic EL display substrate of a top emission type that is shown in FIG. 1, examples of suitable device substrates 100 include: (a) a transparent support; (b) a transparent support having a color filter layer provided thereon; and (c) organic EL element intermediate bodies in which an organic EL layer and one electrode (preferably, a transparent electrode) constituting an organic EL element are laminated on a support (preferably a transparent support), but these examples are not limiting.

The TFT substrate 12 used as a support for a device substrate 100 shown in FIG. 1 has a structure in which TFT constituting switching elements and wirings for driving the switching elements are provided on a glass or silicon substrate.

The reflecting electrode 14 is composed of a plurality of partial electrodes, and partial electrodes are connected at a one-to-one ratio to switching elements configured of TFT. The reflecting electrode 14 can be formed by a dry process such as vapor deposition or sputtering by using a metal (Al, Ag, Mo, W, Ni, Cr, and the like), an amorphous alloy (NiP, NiB, CrP, CrB, and the like), or a microcrystalline alloy (NiAl) with a high reflectivity.

The organic EL layer 16 comprises at least an organic light-emitting layer and has a structure in which a hole-injecting layer, a hole transport layer, an electron transport layer, and an electron-injecting layer are introduced, as necessary. Alternatively, a hole-injecting and transport layer or an electron-injecting and transport layer having a function of injecting and transporting holes or electrons may be also used. Well-known materials can be used for each layer constituting the organic EL layer 16. Further, the layers constituting the organic EL layer 16 can be formed by using any method known in the pertinent technical field, such as vapor deposition.

The transparent electrode 18 can be formed by using ITO, tin oxide, indium oxide, IZO, zinc oxide, zinc-aluminum oxide, zinc-gallium oxide, or conductive transparent metal oxides obtained by adding dopants such as F and Sb to these oxides. The transparent electrode 18 can be formed using a dry process such as vapor deposition, sputtering, or chemical vapor deposition (CVD), and is preferably formed using the sputtering process. In the organic EL display substrate shown in FIG. 1, the transparent electrode 18 is a common electrode formed over the entire surface of the organic EL layer 16.

The deposition panel 200 has a structure comprising a substrate 20, a plurality of heating elements 22 arranged on the substrate 20, and a deposition material layer 24 arranged as an outermost surface layer on the plurality of heating elements 22.

The substrate 20 can be formed from a heat-resistant material that can withstand the temperature at which the deposition material layer 24 is deposited. Glass, quartz, and the like can be used as the heat-resistant material with insulating properties for forming the substrate 20. Further, when a substrate 20 is formed by using an electrically conductive heat-resistant material such as a metal, it is preferred that a heat-resistant insulating film (not shown in the figures) be provided on the surface thereof.

The plurality of heating elements 22 can be formed using resistor materials such as noble metal materials with a high melting point (Pt—W, Pt—Rh, Pt—Ir, and the like) silicide materials (MoSi₂ and the like), carbon-containing materials (SiC and the like), and metal materials with a high melting point (NiCr, Mo, Cr, Ta, Ta₂N, and the like). For example, a plurality of heating elements 22 having the predetermined pattern can be formed by depositing the aforementioned materials on the substrate 20 by sputtering and treating with the usual etching process.

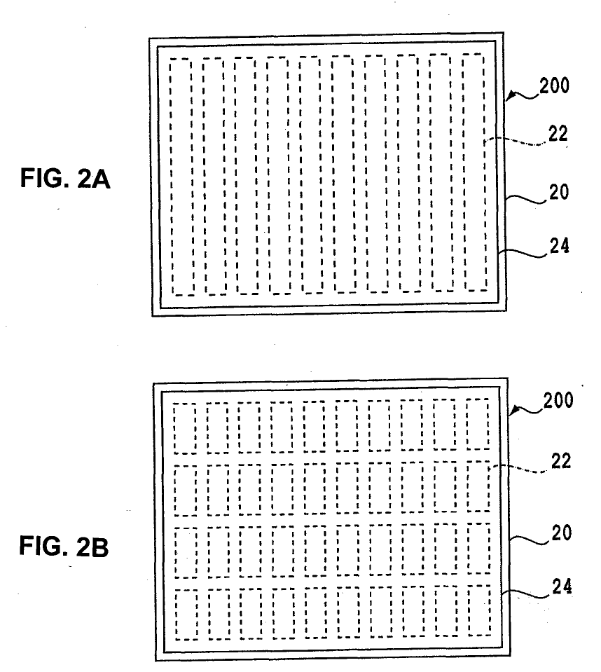

A plurality of heating elements 22 may have a linear shape shown in FIG. 2A or an island-like shape shown in FIG. 2B. When they have an island-like shape, any heating elements 22 can be selectively heated and the degree of freedom in pattern shape selection of the obtained thin film of deposition material can be increased by arranging the wirings for driving the plurality of heating elements 22 in a matrix-like fashion.

The deposition material layer 24 formed on the plurality of heating elements 22 may be a layer comprising an organic material or a layer comprising an inorganic material. Examples of suitable organic materials include color conversion materials, color filter materials, and organic EL layer materials. Examples of suitable inorganic materials include electrode materials. The deposition material forming the deposition material layer 24 may be a sublimable material that is directly evaporated from a solid state or a meltable material that is evaporated after assuming a liquid state. Further, the deposition material may be a single substance or a mixture of a plurality of materials. When a mixture of a plurality of materials is used as the deposition material, the heating temperature of the heating elements 22 is so adjusted that the material with the highest evaporation temperature can be evaporated, but other materials are not decomposed.

In accordance with the present invention, the deposition material layer 24 is formed by vapor depositing the deposition material on the substrate 20 where the plurality of heating elements 22 has been formed. A vapor deposition method using resistance heating or a vapor deposition method using electron beam heating can be used for vapor deposition. It is possible to prepare a mixture in advance in which a plurality of materials are mixed at a predetermined ratio and then perform co-deposition by using the prepared mixture. Alternatively, a plurality of materials may be disposed in separate heating zones and then co-deposition may be performed by heating each material separately. The latter method is especially effective when there is a significant difference in properties (deposition rate, vapor pressure, etc.) between the materials.

When a material having the electric conductivity of an electrode is used as the deposition material, it is preferred that a heat-resistant insulating layer (not shown in the figure) be provided between the heating elements 22 and deposition material layer 24. The heat-resistant insulating layer has a function of preventing the leak of electric current serving to generate heat. The heat-resistant insulating layer can be formed using a heat-resistant oxide such as Al₂O₃ or WO₃. The heat-resistant insulating layer preferably has a thickness that is sufficiently large to provide electric insulation between the heating elements 22 and deposition material layer 24 and sufficiently thin to avoid inhibiting thermal conductivity from the heating elements 22 to the deposition material layer 24.

A color conversion material that can be used as the deposition material in accordance with the present invention is composed of one or a plurality of color conversion colorants. When a color conversion material comprising a single color conversion colorant is used, the color conversion colorant preferably absorbs a blue component of light generated by the organic EL layer 16 serving as a light source and emits a light component in a different wavelength range. Examples of colorants that can be advantageously used as a single color conversion colorant constituting the color conversion layer include coumarin colorants such as 3-(2-benzothiazoyl)-7-diethylaminocoumarin (Coumarin 6), 3-(2-benzoimidazolyl)-7-diethylaminocoumarin (Coumarin 7), and Coumarin 135 and naphthalimido colorants such as Solvent Yellow 43 and Solvent Yellow 44.

When a color conversion material comprising two color conversion colorants (first and second color conversion colorants) is used, the first color conversion colorant serves to absorb a blue component of light generated by a light source and transfer the absorbed energy to the second colorant. Therefore, the absorption spectrum of the first color conversion colorant preferably overlaps the light generation spectrum of the color source. It is more preferred that the absorption maximum of the first color conversion colorant match the maximum of the light emission spectrum of the light source. Further, the light emission spectrum of the first color conversion colorant preferably overlaps the absorption spectrum of the second color conversion colorant. It is even more preferred that the maximum of the emission spectrum of the first color conversion colorant match the absorption maximum of the second color conversion colorant. Colorants that can be advantageously used as the first color conversion colorant in accordance with the present invention include the aforementioned coumarin colorants and naphthalimido colorants. The first color conversion colorant is preferably contained at 90 wt. % or more, more preferably 90 to 99.99 wt. % based on the total weight of the color conversion material. When the first color conversion colorant is present in such a concentration range, light from the light source can be sufficiently absorbed and the absorbed light energy can be transferred to the second color conversion colorant.

The second color conversion colorant receives the energy transferred from the first color conversion colorant and emits light. Examples of colorants that can be advantageously used as second color conversion colorants in accordance with the present invention include cyanine colorants such as 4-dicyanomethylene-2-methyl-6-(p-dimethylaminostyryl)-4H-pyran (DCM-1, (I)), DCM-2 (II), and DCJTB (III); 4,4-difluoro-1,3,5,7-tetraphenyl-4-bora-3a,4a-diaza-s-indacene (IV), Iumogen F red, and Nile Red (V). Alternatively, xanthene colorants such as Rhodamine B and Rhodamine 6G or pyridine colorants such as pyridine 1 may be used as the second color conversion colorant.

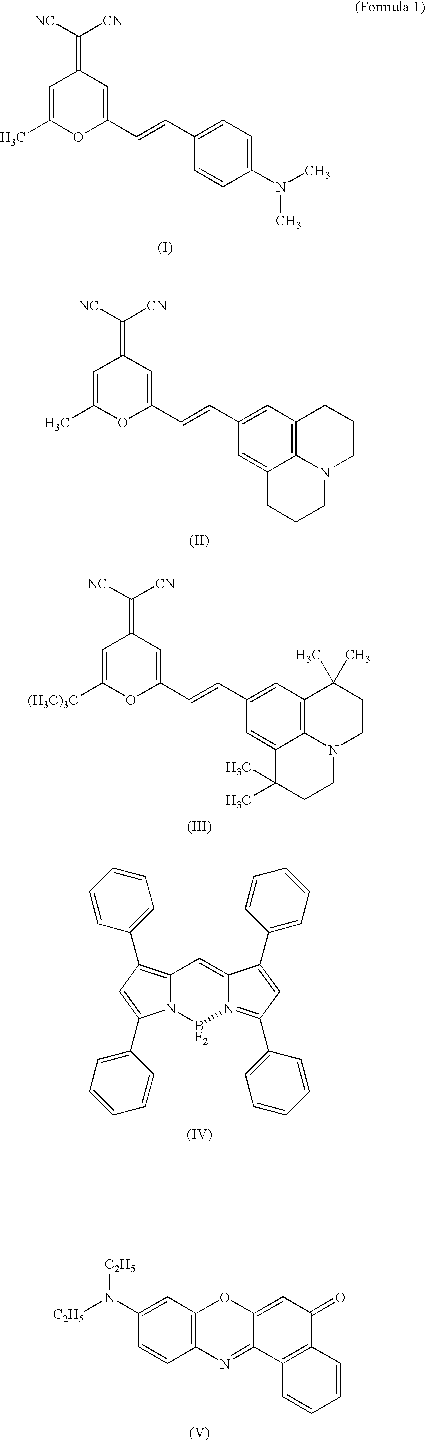

When a color conversion material comprising two color conversion colorants is used, the difference in wavelength between the light prior to conversion and after conversion can be increased compared to the case where a single color conversion colorant is used. Such an increase is especially useful for converting blue light into light in a long wavelength region, such as red light. The content of the second color conversion colorant can change depending on the types of the first and second color conversion colorants that are used, the desired color conversion intensity (conversion efficiency), and target application. Generally, the preferred concentration of the second color conversion colorant is 10 wt. % or less, preferably within a range of 0.01 to 10 wt. %, and more preferably 0.1 to 5 wt. % based on the total weight of the color conversion materials.

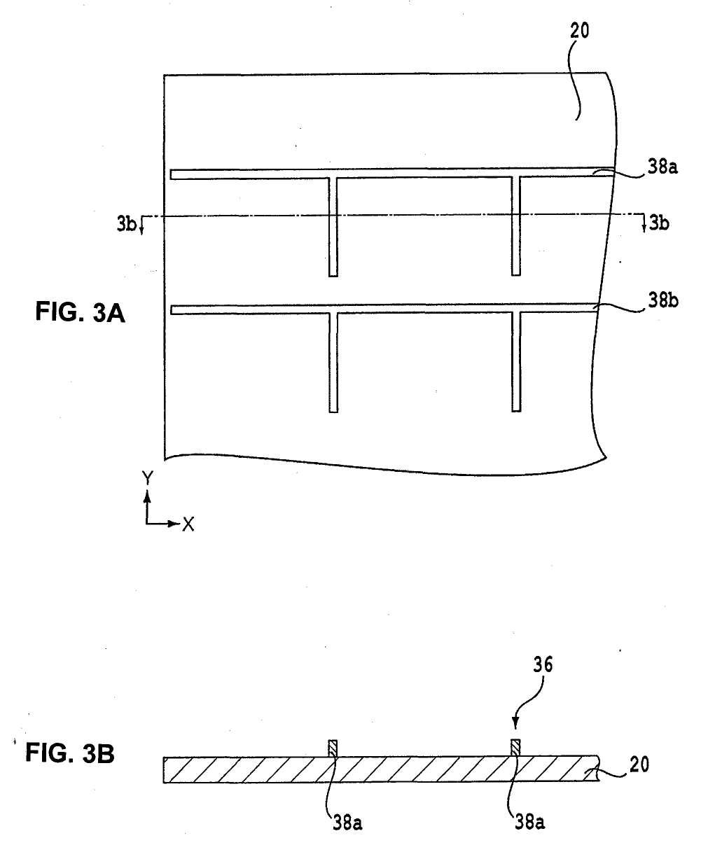

A method for manufacturing a deposition panel having a plurality of heating elements 22 having an island-like shape and matrix-shaped wirings will be explained below with reference to FIGS. 3 through 6.

First, a film of a conductive material is formed on the substrate 20, the film is patterned, and X wirings 38 (a, b . . . ) such as shown in FIG. 3 are formed. FIG. 3A is a top surface view, and FIG. 3B is a cross-sectional view along the cutting line 3b-3b. The X wirings have trunk portions that extend in one direction (X direction) and branches (extend in the Y direction) that are T-like from the trunk portions. Examples of conductive materials that can be used for forming the X wirings 38 include Al, Ti, Ni, Mo, Cu, and Ag. Any method known in the pertinent technical field, such as a sputtering method, can be used for depositing the conductive material. Any method known in the pertinent technical field, such as a photolithography method employing wet etching or the like, can be used for patterning the conductive material.

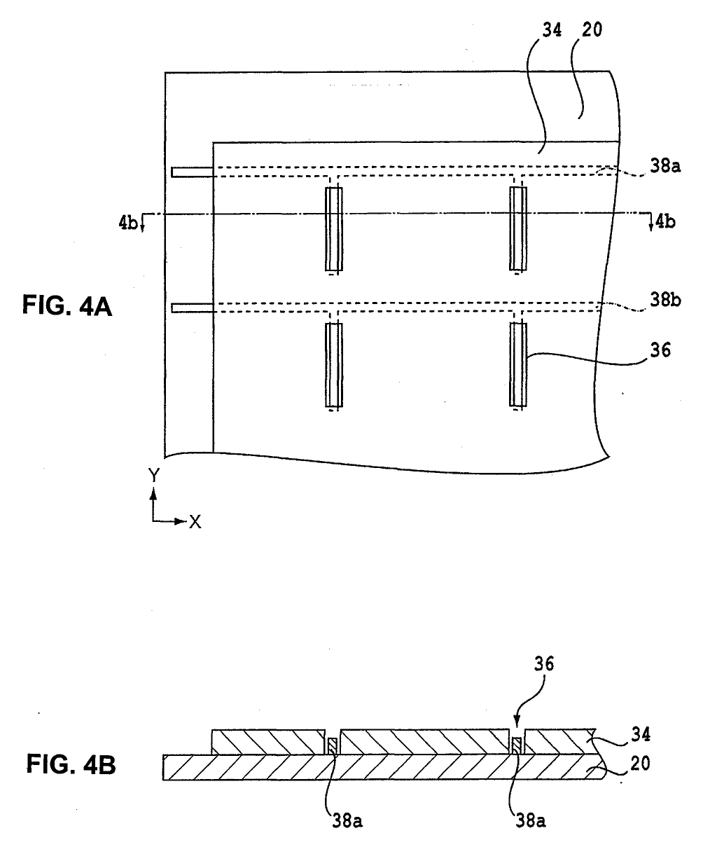

FIG. 4A is a top surface view, and FIG. 4B is a cross-sectional view along the cutting line 4b-4b. An insulating film 34 is then formed to cover the X wirings 38, except the end sections of the trunk portions and branches. The end sections of the trunk portions of the X wirings 38 are used as contacts with an external connection circuit, and the branches of the X wirings 38 are used as contacts with a plurality of heating elements 22. Initially, an electrically insulating material such as SiOₓ or SiNₓ is deposited using a sputtering method or CVD method. The insulating film 34 has a thickness of 0.3 to 1 μm. Then, contact holes 36 are formed using drying etching, such as to expose the branches of the X wirings 38, and the insulating film 34 is obtained. For example, reactive ion etching (RIE) using CF₄ gas can be used as a suitable dry etching method.

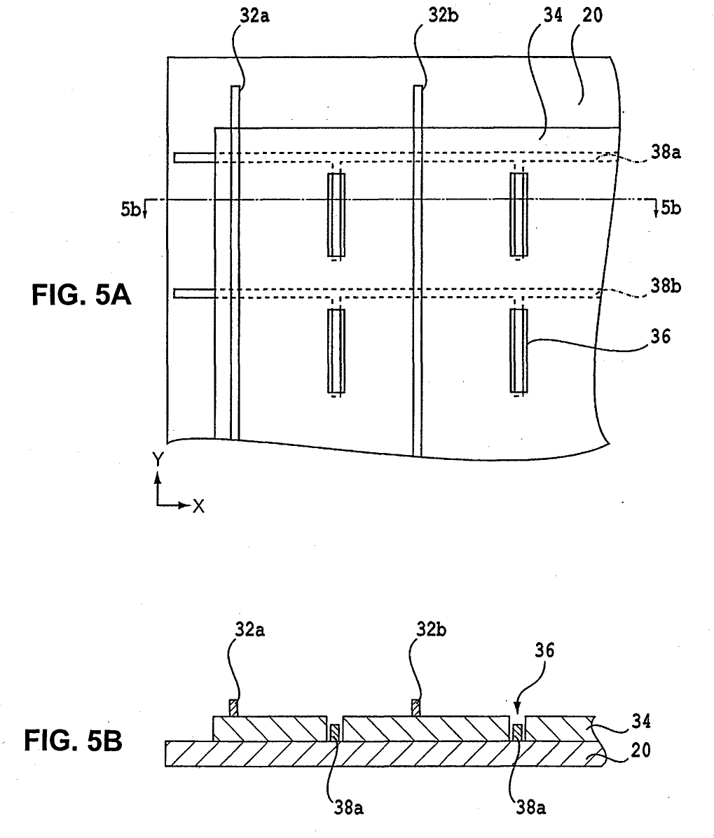

A conductive material film is then formed on the insulating film 34, and the film is patterned to form Y wirings 32 (a, b . . . ) such as shown in FIGS. 5A and 5B. FIG. 5A is a top surface view, and FIG. 5B is a cross-sectional view along the cutting line 5b-5b. The Y wirings extend in the direction crossing the extension direction of trunk portions of the X wirings 38, preferably at a right angle (Y direction). The Y wirings 32 do not have branches and a plurality of heating elements 22 are connected to the trunk portions thereof. The Y wirings 32 can be formed by using the same material and method as those used for the X wirings 38, except that no branches are formed. If necessary, the end sections and branches of the trunk portions of the exposed X wirings can be protected before forming the conductive material film. For example, such protection can be performed by forming a resist mask that covers the end sections and branches of the trunk portions of the exposed X wirings before forming the conductive material film and removing the resist mask after patterning the conductive material film.

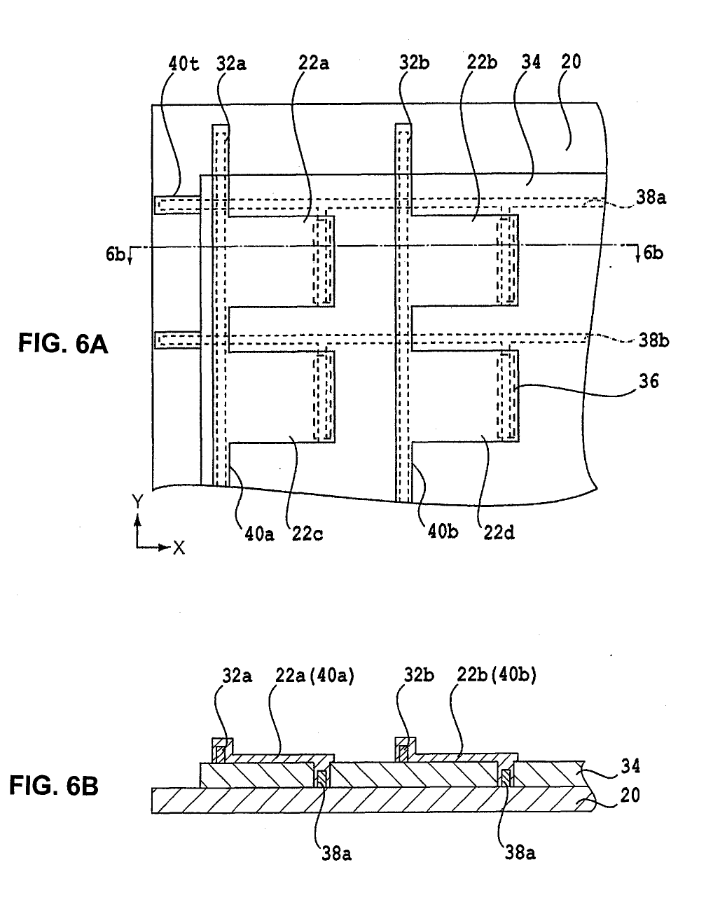

Finally, a plurality of heating elements 22 (a, b . . . ) that are connected to the X wirings 38 and Y wirings 32 are formed, as shown in FIGS. 6A and 6B. A resistor layer 40 obtained by depositing a resistor material over the entire surface is patterned by using any method known in the pertinent technical field, such as wet etching. FIG. 6A is a top surface view, and FIG. 6B is a cross-sectional view along the cutting line 6b-6b. Here, the resistor layers 40 (a, b) are patterned so as to cover the Y wirings 32 and the exposed branches of the X wirings 38 that are connected to respective Y wirings. The resistor layers 40 in the regions between the Y wirings 32 and the exposed branches of the X wirings 38 connected thereto function as heating elements 22 (a to d). Further, the exposed end sections of the X wirings 38 are also covered by resistor layers 40t formed independently. By employing the above-described configuration, it is possible to prevent the materials of the X wiring 38 and Y wiring 32 from leaching during wet etching of the resistor layer 40 (heating elements 22).

A plurality of X wirings 38 are connected to a power source (not shown in the figure) via switches (not shown in the figure) connected to the end sections thereof. Likewise, a plurality of Y wirings 32 are connected to a power source (not shown in the figure) via switches (not shown in the figure) connected to the end sections thereof. By creating such a configuration, it is possible to generate heat by passing electric current only to one heating element 22a, for example, by turning ON the switch connected to one Y wiring 32a and one X wiring 38a. In this case, because of the difference in electric conductivity between the wiring material and resistor material, the electric current does not flow in the resistor layer 40a located above the Y wiring 32a outside the region of the heating element 22a, and the resistor layer in the respective zone generates no heat. Alternatively, a plurality of heating elements 22 may be simultaneously caused to generate heat by turning ON the switches connected to one Y wiring 32 and a plurality of X wirings 38. Thus, by appropriately selecting the Y wirings 32 and X wirings 38 for energization, it is possible to evaporate selectively only the deposition material 24 in a desired location and obtain a vapor-deposited film of a desired pattern shape.

In the method for patterning the deposition material film in accordance with the present invention the above-described device substrate 100 and deposition panel 200 are first disposed inside a deposition chamber so that the deposition material layer 24 faces the device substrate 100. At this time, the distance between the device substrate 100 and the deposition panel 200 (in FIG. 1, the distance between the surface of the transparent electrode 18 and the surface of the deposition material layer 24) is usually about 1 μm to 1 mm, preferably 50 to 100 μm. In particular, by setting the distance between the device substrate 100 and the deposition panel 200 to 50 to 100 μm, it is possible to obtain the vapor-deposited film 26 with sharp contour without blurring, while preventing contact between the device substrate 100 and the deposition panel 200.

Then, the pressure inside the deposition chamber is reduced to a pressure necessary for implementing usual vapor deposition, preferably to a pressure of 1×10⁻⁴ Pa or less. The heating element 22 in a desired position is then selectively energized, the deposition material layer 24 is evaporated, and a patterned vapor-deposited film 26 is formed on the device substrate 100. When the heating element is energized, DC current, AC current, or pulse current may be used. The energization is usually implemented till the deposition material layer 24 is heated to a preset evaporation temperature, thereby enabling vapor deposition of the deposition material on the device substrate.

The explanation above was conducted with respect to an example in which an organic EL display substrate of a top emission type is used as the device substrate 100 and the color conversion material is vapor deposited. However, the method in accordance with the present invention can be also applied to an organic EL display substrate of a top emission type with a passive matrix drive. The passive matrix drive comprises a reflective electrode, an organic EL layer on the reflecting electrode, and a transparent electrode on a support. The reflective electrode can be composed of a plurality of linear partial electrodes extending in the first direction. The transparent electrode can be composed of a plurality of linear partial electrodes extending in the second direction, wherein the first direction is orthogonal to the second direction. Further, the method in accordance with the present invention can be also used for: (a) vapor depositing a color filter material (a material that transmits only a color component in a specific wavelength region) on a transparent support base (that is, for forming a color filter); (b) vapor depositing a color conversion material on a transparent support base or a transparent support base having a color filter layer (that is, for forming a color conversion filter), or (c) vapor depositing an electrode material on a laminate of a transparent support base, a transparent electrode, and an organic EL layer (that is, of forming an upper reflecting electrode on an organic EL display substrate of a bottom emission type).

### EXAMPLES

### Example 1

A TFT substrate 12 in which a plurality of switching elements composed of TFT were arranged with a pitch of 42 μm in the X direction and a pitch 126 μm in the Y direction on a silicon substrate was disposed inside a DC sputtering apparatus. A CrB film having a thickness of 100 nm and an IZO (In₂O₃—10% ZnO) film having a thickness of 20 nm were formed using a DC sputtering method in which a 300 W sputtering power was applied in an Ar atmosphere. The laminate of the CrB film and IZO film thus obtained was patterned, and a plurality of partial electrodes having dimensions of 32 μm in the X direction and 116 μm in the Y direction are formed for reflecting electrodes 14 arranged with a pitch of 42 μm in the X direction and 126 μm in the Y direction.

The TFT substrate 12 with the reflecting electrodes 14 formed thereon was transferred into a vapor deposition apparatus, and an organic EL layer 16 was formed. During film formation, the internal pressure in the vacuum chamber was reduced to 1×10⁻⁵ Pa. The organic EL layer 16 had a four-layer configuration comprising a hole-injecting layer having a thickness of 80 nm and composed of copper phthalocyanine (CuPc), a hole transport layer having a thickness of 20 nm and composed of 4,4′-bis[N-(1-naphthyl)-N-phenylamino]biphenyl (α-NPD), an organic light-emitting layer having a thickness of 40 nm and composed of 4,4′-bis(2,2-diphenylvinyl)biphenyl (DPVBi), and an electron transport layer having a thickness of 20 nm and composed of aluminum tris(8-hydroxyquinoline) complex (Alq₃).

The TFT substrate 12 having the organic EL layer 16 formed thereon was then transferred into a sputtering apparatus, without disrupting the vacuum. A device substrate 100 was then obtained by forming a transparent electrode 18 from an IZO film having a thickness of 200 nm by sputtering in an Ar atmosphere (pressure 0.3 Pa) using IZO (In₂O₃—10% ZnO) as a target.

A Mo film with a thickness of 100 nm was formed on a quartz substrate 20 having a thickness of 5 mm by using a sputtering method. Then, the Mo film was etched using a mixed etchant comprising phosphoric acid, nitric acid, and acetic acid, and 1000 heating elements 22 having a linear shape extending in the Y direction were formed. The line of each heating element 22 had a width of 32 μm and a length of 30 mm, and the heating elements were arranged with a pitch of 42 μm in the X direction (that is, the spacing between lines was 10 μm).

The substrate 20 having the heating element 22 formed thereon was transferred into the vapor deposition apparatus, and a deposition panel 200 was obtained by forming a deposition material layer 24. The deposition material layer 24 was composed of two kinds of color conversion material by co-deposition in which Coumarin 6 and DCM-2 were heated in separate crucibles inside the vapor deposition apparatus. At this time, the heating temperature of each crucible was controlled so that the deposition rate of Coumarin 6 was 0.3 nm/s and the deposition rate of DCM-2 was 0.005 nm/s. The deposition material layer 24 thus obtained had a thickness of 200 nm. Further, the deposition material layer 24 that was thus obtained contained DCM-2 at 2 mol %, based on the total number of molecules (in this case, the molar number of the entire colorant) constituting the deposition material layer 24 (in other words, the Coumarin 6:DCM-2 molar ratio was 49:1).

The device substrate 100 and deposition panel 200 thus obtained were disposed inside a vacuum chamber so that the transparent electrode 18 and the deposition material layer 24 faced each other. At this time, the distance between the surface of the transparent electrode 18 and the surface of the deposition material layer 24 was 100 μm. Then, a pulsed electric current was passed to groups of three heating elements 22, the deposition material layer 24 was heated to an evaporation temperature of 310° C., and a patterned vapor-deposited film 26 was formed on the transparent electrode 18. The obtained vapor-deposited film 26 comprised a plurality of linear portions extending in the Y direction, each linear portion had a width of 35 μm, and the linear portions were arranged with a pitch of 126 μm in the X direction (in other words, the spacing between lines was 91 μm).

### Example 2

An Al film having a thickness of 1 μm was formed using a sputtering method on a quartz substrate 20 having a thickness of 5 mm. Then, a plurality of X wirings 38 were formed by a photolithography method using the usual wet etching process. Each of a plurality of X wirings 38 had a trunk portion extending in the X direction and a plurality of branches that were branched out from the trunk and extended in the Y direction. Trunk portions of the X wirings 38 were arranged with a pitch of 42 μm in the Y direction. Further, the branches of X wirings 38 had a linear shape with a length of 24 μm that extended in the Y direction; the branches were arranged with a pitch of 42 μm in the X direction. The trunks and branches of the X wirings had a width of 10 μm.

A SiOₓ film having a thickness of 300 μm was deposited by a sputtering method so as to cover the X wirings 38. Then, an insulating film 34 was obtained by forming contact holes 36 by RIE using CF₄ gas so as to expose the branches of X wirings 38.

A resist mask was then formed to protect the exposed branches of the X wiring 38. Then, an Al film having a thickness of 1 μm was formed using a sputtering method. A plurality of Y wirings 32 were then formed by a photolithography method using the usual wet etching process. The resist mask was then removed and the branches of X wirings 38 were again exposed. The Y wirings 32 had a linear shape with a width of 10 μm, extended in the Y direction, and were arranged with a pitch of 42 μm in the X direction. A spacing between one Y wiring 32 and a branch of one X wiring connected thereto via the heating element 22 was 20 μm.

Then, a MoCr (Cr 5%) film having a thickness of 100 nm was formed using a sputtering method. The MoCr film was then etched using a mixed etchant comprising phosphoric acid, nitric acid, and acetic acid. As shown in FIG. 6A, a resistor layer 40 was formed that covered Y wirings 32, the regions between the Y wirings 32 and exposed branches of X wirings 38 and also the exposed end sections of X wirings 38, and a plurality of heating elements 22 were obtained. Each heating element 22 had a size of 32 μm in the X direction and 116 μm in the Y direction, and the heating elements were arranged with a pitch of 42 μm in the X direction and a pitch of 126 μm in the Y direction.

Co-deposition of Coumarin 6 and DCM-2 was then performed in the same manner as in EXAMPLE 1, and a deposition panel 200 was obtained. A device substrate 100 was formed using the same procedure as that of EXAMPLE 1.

The device substrate 100 and deposition panel 200 thus obtained were disposed inside a vacuum chamber so that the transparent electrode 18 and the deposition material layer 24 faced each other. At this time, the distance between the surface of the transparent electrode 18 and the surface of the deposition material layer 24 was 100 μm. Then, a pulsed electric current was passed to groups of three X wirings and all Y wirings, groups of three heating elements 22 in the X direction were heated, the deposition material layer 24 was heated to an evaporation temperature of 310° C., and a patterned vapor-deposited film 26 was formed on the transparent electrode 18. The obtained vapor-deposited film 26 comprised a plurality of rectangular portions having a size of 35 μm in the X direction and 119 μm in the Y direction. The rectangular portions were arranged in the form of a matrix with a pitch of 126 μm in the X direction and a pitch of 126 μm in the Y direction.

The invention has been described with respect to certain preferred embodiments thereof. It will be understood that modifications and variations are possible within the scope of the appended claims.

This application is based on, and claims priority to, Japanese Patent Application No. 2007-008423, filed on Jan. 17, 2007. The disclosure of the priority application, in its entirety, including the drawings, claims, and the specification thereof, is incorporated herein by reference.

What is claimed is:

1. A method for manufacturing a patterned vapor-deposited film, the method comprising:
preparing a deposition panel comprising a substrate, a plurality of heating elements, and a deposition material layer formed on the plurality of heating elements, the deposition material layer forming the outermost surface;
disposing the deposition panel and a device substrate so that the deposition material layer faces the device substrate; and
causing at least some of the plurality of heating elements to generate heat, selectively evaporating the deposition material layer that is positioned on the heating elements that have generated heat, and vapor depositing on a surface of the device substrate to form a vapor-deposited film.

2. The method for manufacturing a patterned vapor-deposited film according to claim 1, using the deposition panel in which the plurality of heating elements are arranged in an island-like fashion on the substrate, wirings for supplying an electric current to the plurality of heating elements are arranged in a matrix-like fashion, and each of the plurality of heating elements can be selectively caused to generate heat.

3. The method for manufacturing a patterned vapor-deposited film according to claim 1, using the deposition panel in which the plurality of heating elements are arranged in a line-like fashion on the substrate, and each of the plurality of heating elements can be selectively caused to generate heat.

4. The method for manufacturing a patterned vapor-deposited film according to claim 1, wherein the deposition material layer is formed from a color conversion material.

5. The method for manufacturing a patterned vapor-deposited film according to claim 1, wherein the device substrate is an organic EL display substrate of a top emission type in which a reflecting electrode, an organic EL layer, and a transparent electrode are laminated in this order on a support base.
